(19) United States
(12) Patent Application Publication
(10) Pub. No.: US 2015/0057021 A1
(43) Pub. Date: Feb. 26, 2015

(54) System and method for identification, processing and presentation of specified property and nearby area environmental contamination

(71) Applicant: Todd Alan Kuhlmann, Austin, TX (US)

(72) Inventor: Todd Alan Kuhlmann, Austin, TX (US)

(21) Appl. No.: 13/970,863

(22) Filed: Aug. 20, 2013

(51) Int. Cl. H04W 4/02

(52) U.S. Cl. CPC H04W 4/02
USPC 455/456.3

(57) ABSTRACT

A system and method for identification of the specified property and nearby area environmental contamination using a communication network includes a wireless user display device communicating over the network with a server and the server communicating with an environmental contamination database over a wired or wireless communication network. The method includes selecting geographic location of the specified property and nearby area of interest on the wireless user display device and then requesting the server for the environmental contamination information of the specified property and nearby area. The server then communicates with the environmental contamination database and request for the specified property and nearby area specific environmental contamination information. The environmental contamination database extracts the requested information and transmits the generated report back to server which further processes the received information for generating a wireless user display device ready report format which further enables the user to save, edit and share the generated information over the wireless communication network with other users.

### FIELD OF THE INVENTION

The present invention relates generally to a surface or subterranean contamination identification and analysis system, and more particularly to a system for identification, processing and presentation of the area contamination levels and associated threats.

### BACKGROUND OF THE INVENTION

Environmental reports are prepared for a real estate holding that identifies potential or existing environmental contamination liabilities. The analysis, typically addresses both the underlying land as well as physical improvements to the property. In order to determine the ideal property for residential purpose or for commercial purpose, it is very important to identify property's environmental contaminants for commercial value evaluation and for the selection of the right property as per the end requirements. The local government databases and national ecological databases are one of the possible sources available for extracting environmental information with respect to location or area of the interest but these databases are not commercially prepared and the information is scattered that is of no use to property owners or civil engineers.

Another disadvantage of current property environmental contaminant information system is that the information is not linked with the legal or national and international standard databases which limit the available information to contaminants only. The owner of the property and associated civil engineers cannot determine the legal liabilities associated with the property of their interest. This information is not readily available and access to information is also difficult as one has to access many databases and have to request local administration or government representatives for getting access to these databases. This process of collecting environmental contaminant information of area or property of interest is slow and time consuming.

Further, many new technologies have become an integral part of our life and users are now become accustomed to rapid and easy access to data even when they are moving. Mobile devices are one of the technologies that have changed our day to day life and have become an easy to use tool for information extraction and presentation. Many Smartphone and tablet applications are easily available today in which location-dependent data can be requested and displayed in an easy to read user friendly interface. The above mentioned Smartphone and tablet applications, such as but not limited to, weather monitoring, meter reading, evaluation of traffic condition requires a large amount of data to be collected from geographically dispersed locations. It is very expensive and labor intensive work to install and maintain the systems for identification and transmission of the location specific or area specific data.

Thus there is a need of a system and method that can identify location specific property environmental contamination information from the already maintained available knowledge databases of the local administration and national government databases and to present the requested information on the user's display devices.

### SUMMARY OF THE INVENTION

To solve the problems described above, the present invention provides following solutions.

In a preferred embodiment of the present invention there is provided a system and method for identification and presentation of the specified property and nearby area environmental contaminant information comprising a user display device which enables the user to request specified property and nearby area environmental contaminant information and to view the requested information on the user display device.

In another embodiment of the present invention, the system further includes a webservice request created by the user display device comprising a user access verification data to validate user's access to a server. The server receives the user' current location and/or location specific request from the user display device in the form of the webservice request. Once the user access is validated by the server, the server then sends specified property and nearby area environmental contamination information request to a property environmental contaminant information database which is in wired or wireless communication network with the server. The property environmental contaminant information database sends back the requested specified property and nearby area environmental contaminant information to the server.

In another embodiment of the present invention, the user location is determined by using a global positioning system of the user's display device.

In a further embodiment of the present invention, the specified property and nearby area environmental contaminant data relates to chemical, radioactive, surface, subterranean and geological attributes of the location.

In a preferred embodiment of the present invention, the property environmental contaminant database includes database that has been created and compiled by other sources, such as but not limited to, the EPA, State and Local agencies.

In another embodiment of the present invention, the server converts received specified property and nearby area environmental contaminant information from the property environmental contaminant database into the user display device readable format.

In another embodiment of the present invention, the user display device presents the transmitted information in an easy to read format, such as but not limited to, maps, graphs or the like.

In further embodiment of the present invention, the user can share, print, upload or email the presented environmental contaminant information to other users using the wireless communication network.

Further features and advantages of the present invention, as well as the structure and operation of various embodiments of the present invention, are described in detail below with reference to the accompanying drawings.

### BRIEF DESCRIPTION OF THE DRAWINGS

For the purpose of illustration, there are shown in the drawings certain embodiments of the present invention wherein like reference numbers generally indicate identical, functionally similar, and/or structurally similar elements. It should be understood that the invention is not limited to the precise arrangements, dimensions, and instruments shown.

FIG. 1 depicts specified property and nearby area environmental contaminant identification and reporting system according to an exemplary embodiment of the present invention;

FIG. 2 depicts a method of specified property and nearby area environmental contaminant identification and reporting system according to an exemplary embodiment of the present invention;

FIG. 3 depicts an exemplary embodiment of a user display device according to an exemplary embodiment of the present invention;

FIG. 4 depicts another exemplary embodiment of a user display device illustrating an input keypad and a search box; and

FIG. 5 depicts an exemplary embodiment of a user display device illustrating specified property and nearby area environmental contaminant report according to an exemplary embodiment of the present invention.

### DETAILED DESCRIPTION OF THE INVENTION

In this section, some preferred embodiments of the present invention are described in detail sufficient for one skilled in the art to practice the present invention. It is to be understood, however, that the fact that a limited number of preferred embodiments are described herein does not in any way limit the scope of the present invention as set forth in the appended claims. It is also to be understood that a person skilled in the relevant art will recognize that other components and configurations can be used without parting from the spirit and scope of the invention.

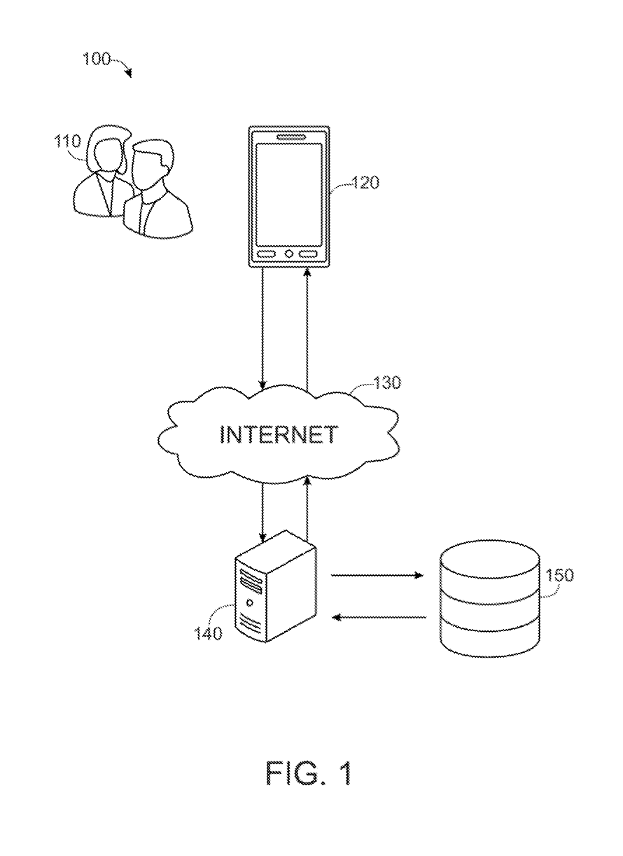

Referring to FIG. 1, there is shown a specified property and nearby area environmental contaminant identification and reporting system 100 comprising a user 110 and a user display device 120. The user display device 120 is using a wireless communication network 130 for transmitting and receiving information from a server 140 located at a secure location. The server 140 is further transmitting and receiving information from a property environmental contaminant database 150, such as but not limited to EPA, State or Local agencies, local property administration and national government databases which are already maintained and readily available environmental contaminant databases.

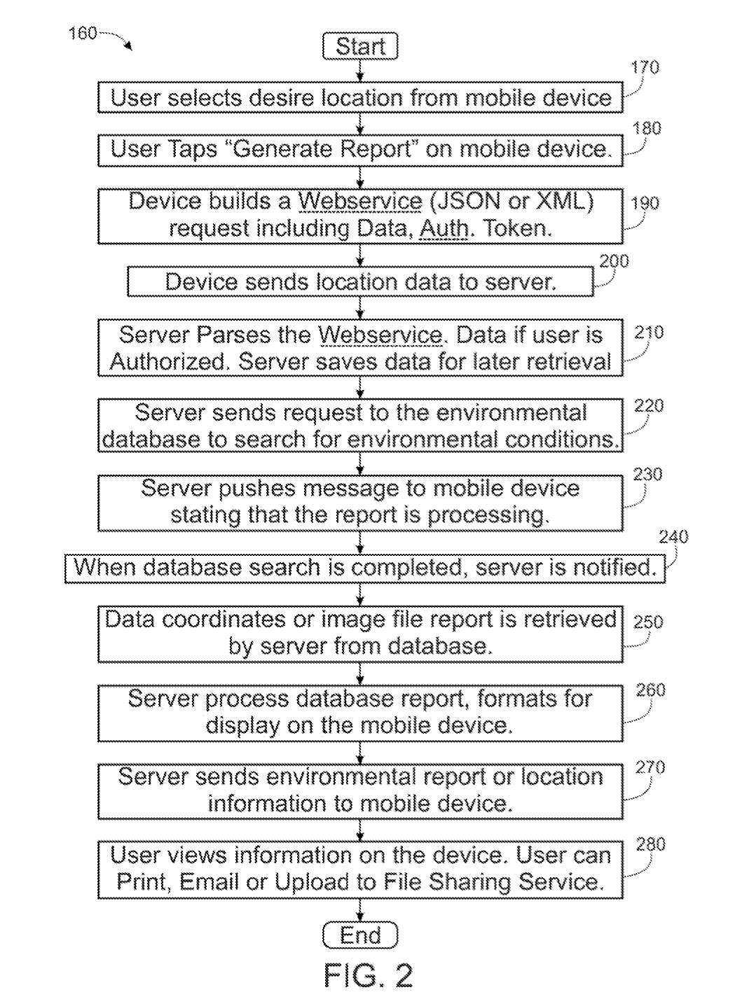

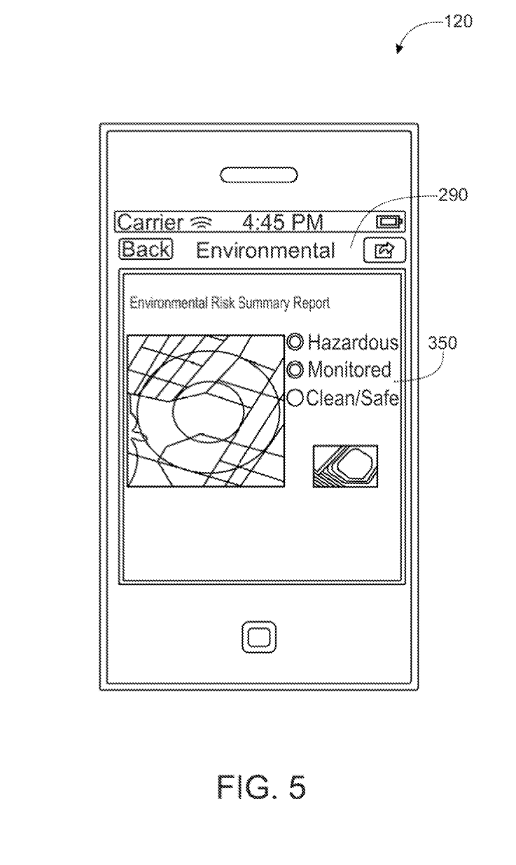

Referring to FIG. 2, there is shown a method for reporting specified property and nearby area environmental contaminants 160 in operation. At block 170, the user 110 selects a specified property and nearby area on the user display device 120. At block 180, the user 110 selects an option on the user display device 120 by using the selection toolbar 320 for generating specified property and nearby area environmental contamination identification report 350 (as shown in FIG. 5). At block 190, the user display device 120 creates a webservice request in a preferred format, such as but not limited to, JSON or XML format comprising the user 110 authentication or registration data. At block 200, the user display device 120 transmits the webservice request to the server 140 through a wireless communication network 130. At block 210, the server 140 process the received webservice request and validate the authentication of registration data of the user 110 and if the user 110 is authorized for access then the server 140 saves the registration data for future use so as to provide quick and efficient access to server 140. At block 220, the server 140 transmit received specified property and nearby area environmental contamination identification information request from user display device 120 to the property environmental contamination database 150 to search for the requested specified property and nearby area environmental contamination identification information. At block 230, the server 140 sends a message to the user display device 120 stating that the requested property environmental contamination information is processing. At block 240, the property environmental contamination database 150 transmits the extracted specified property and nearby area environmental contamination information to server 140 in the form of a notification message. At block 250, the server 140 retrieves the data coordinate or the image file as transmitted by the property environmental contamination database 150. At block 260, the server 140 further processes the received information into the file format acceptable by the user display device 120. At block 270, the server 140 transmits the processed information to the user display device 120. At block 280, the user 110 review the transmitted information presented as a specified property and nearby area environmental contamination information report 350 on the user display device 120 which further enables the user 110 for printing sharing or uploading the displayed specified property and nearby area environmental contamination identification information on various social or file sharing sources.

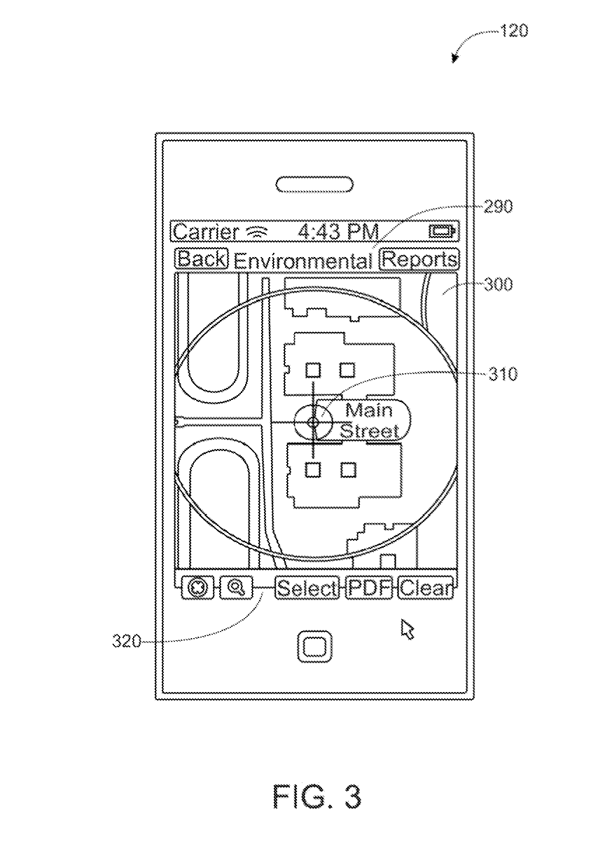

FIG. 3 shows the user display device 120 embodiment suitable for selecting or inputting and then transmitting user 110 specific requests for specified property and nearby area environmental contamination identification information to the server 140. The user display device 120 comprises an information display interface 290 on which the requested specified property and nearby area environmental contamination information is displayed in an easy to read format as created by the server 140; a map display 300 which creates an easy to read information for displaying on the user display device 120; a location indicator 310 which helps in selecting and reading the user 110 specific location on the display of the user display device 120; a selection toolbar 320 which provides selection options to the user 110 for performing various actions for generating and saving the requested specified property and nearby area environmental contamination information.

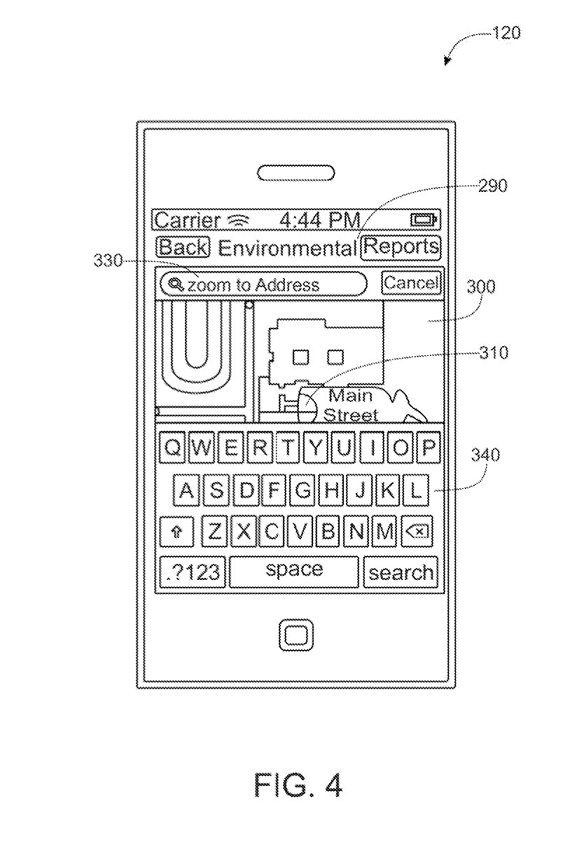

FIG. 4 shows another preferred embodiment of the present invention for inputting the user 110 specified property and nearby area request for identifying property environmental contamination in or around the specified location by the user 110 using the display device 120. The information display interface 290 also provides an input keypad 340 which is generally used in current communication devices for inputting user 110 specific instructions manually. An address box 330 displays the inputted location request for user review and final selection before transmitting the request to the server 140.

FIG. 5 shows the user display device 120 displaying the specified property and nearby area environmental contamination information report 350 to the user 110 using the information display interface 290.

In a preferred embodiment of the present invention there is provided a system and method for identification and presentation of the specified property and nearby area environmental contaminations. The user 110 uses the user display device 120, such as but not limited to, mobile phone, Smartphone, tablet, GPS devices, PDA, Laptop, Palmtop for inputting a specified property and nearby area either by using the global positioning system of the display device 120 which automatically associates the device location with the location input by the user or entering the specified property and nearby area location information manually by using the input keypad 340 of the user display device 120 which further includes identifying and selecting the location name along with the associated geographic coordinates. The user 110 submits the specified property and nearby area environmental contamination information request along with the webservice request to the server 140 by using the selection toolbar 320. The webservice access request comprises the user 110 registration information in a device preferred file format, such as but not limited to, JSON or XML format which is transmitted to the server 140 for validating access for requesting and receiving specified property and nearby area environmental contaminant information. The server 140 stores the received and authorized user information for future use. The server 140 receives the webservice request first and once the user is authorized for access to the server 140, the specified property and nearby area environmental contamination information request from the user display device 120 is executed by the server 140. The server 140 transmits the received specified property and nearby area environmental contamination information request to the property environmental contamination information database 150. The user display device 120 and the server 140 uses the wireless communication network for transmitting and receiving the information. The server 140 and the property environmental contaminant information database 150 uses a wired or wireless communication network for transmitting and receiving information. The server 140 notifies the user device 120 that the requested information is processing. The property environmental contamination information database 150 notifies the server 140 that the requested information has been identified and the server 140 then retrieves the data coordinates or image information from the transmitted information by the property environmental contamination information database 150. The retrieved information comprises details of the contaminations, such as but not limited to, asbestos containing building materials, lead-based paint, lead in drinking water, mold, radon, wetlands, threatened, endangered species, mercury poisoning, debris blow, earthquake hazard, vapor intrusion details in the searched building material, soil, neighboring building material, soil, associated infrastructure that are above or below the ground. The server 140 then processes the retrieved information and creates the user display device 120 readable format and transmits the processed information to the user display device 120. The user display device 120 displays the transmitted information in a easy to read format, such as but not limited to, JSON, XML, maps, graphs or the like which can further be shared, printed, uploaded or email to other users inside or outside the user contacts.

Although the present invention has been described in detail with reference to certain examples thereof, it may be also embodied in other specific forms without departing from the essential spirit or attributes thereof. For example, the user display device 120 described with reference FIGS. 3-5 may be a smartphone that allows the user 110 to enter an electronic mail address via the input keypad 340 so that the property environmental contamination information can be electronically delivered, Embodiments may also allow the user 110 to enter a postal address should the user 110 wish to receive a high-quality print of the images.

In addition, some embodiments of the present invention may be integrated with property environmental contamination information website or video broadcast system. That is, many property environmental contamination information websites already utilize a plurality of cameras and camera operators to provide live video broadcasts and property environmental contamination information live display. These systems are designed to capture unpredictable live changes in the property environmental contamination information. The present invention can take advantage of this pre-existing property environmental contamination information databases and labor investment to provide information to the user 110. These images may be highly desirable because the unpredictable changes in the property environmental contamination makes it difficult for the user 110 to actually visualize the damages already occurred to property or may occur in the near future.

The present invention and components thereof are also capable of being distributed as a program product in a variety of forms, and applies equally regardless of the particular type of user display device being used to actually carry out the property environmental contamination information distribution.

The accompanying figures and this description depicted and described embodiments of the present invention, and features and components thereof. Accordingly, it is desired that the embodiments described herein be considered in all respects as illustrative, not restrictive, and that reference be made to the appended claims for determining the scope of the invention.

We claim:

1. A specified property and nearby area environmental contaminants identification system, comprising:
a. a wireless user display device;
b. a server in communication with the wireless user display device using wireless communication network, whereby access to said server is validated by a webservice request generated by the wireless user display device;
c. a property environmental contaminant database containing location specific property environmental contamination information which is in communication with the server through a wired or wireless communication network for receiving location specific request from the server and transmitting the requested specified property and nearby area specific environmental contaminants information to the server which further process the transmitted specified property and nearby area environmental contaminant report for generating a wireless user display device acceptable file format and then transmitting the generated specified property and nearby area location specific environmental contaminants information report to the wireless user display device with respect to a specific geographic position and within a proximate distance to the specified geographic position as communicated through the user wireless display device using location reporting means or by manually entering the location through the wireless user display device; and
d. a user display device interface enabling user to share generated specified property and nearby area environmental contaminant report through the wireless communication network.

2. A method for specified property and nearby area environmental contaminants identification, comprising:
a. selecting a specified property and nearby area using a wireless user display device;
b. selecting an option on the wireless user display device for generating a report on specified property and nearby area contamination;
c. generating a webservice request comprising user authentication data;
d. sending webservice request to a server;
e. saving the webservice data on server for future requests;
f. sending the report generation request to a property environmental contamination database;
g. transmitting the generated report to server;
h. processing transmitted report by the server for generating wireless user display ready report format; and
i. providing options on the wireless user display device for sharing the generated report through wireless communication network.

3. The method of claim 2, wherein said wireless user display device includes mobile phone, Smartphone, Tablets, GPS devices, PDA, Laptop, Palmtop and the like.

4. The method of claim 2, wherein selecting a specified property and nearby area on the wireless user display device includes identifying and selecting the location name along with the associated geographic coordinates.

5. The method of claim 2, wherein nearby area environmental contamination is selected using a global positioning system of the user's wireless display device.

6. The method of claim 2, wherein nearby area environmental contamination is automatically associated with user's wireless display device location.

7. The method of claim 2, wherein selecting an option on the wireless user display device for generating the report on specified property and nearby area contamination includes pressing associated button on the wireless user display device.

8. The method of claim 2, wherein said webservice request is created in the JSON or XML format.

9. The method of claim 2, wherein said transmitted report is associated with contaminations in the building material, soil, neighboring building material, soil, associated infrastructure that are above or below the ground.

10. The method of claim 2, wherein said transmitted report includes asbestos containing building materials, lead-based paint, lead in drinking water, mold, radon, wetlands, threatened, endangered species, mercury poisoning, debris blow, earthquake hazard, vapor intrusion details.

11. The method of claim 2, wherein said transmitted report includes chemical, radioactive, surface, subterranean and geological attributes of the location.

12. The method of claim 2, wherein said property environmental contaminant identification database contains property information related to plurality of geographic locations.

13. The method of claim 2, wherein said property environmental contaminant identification database has been created and compiled by EPA, State or Local agencies, local property administration and national government databases.

14. The method of claim 2, wherein said transmitted report is created in the JSON or XML format.

15. The method of claim 2, wherein said selection of specified property and nearby area on the wireless user display device includes location input by using device keypad.
